(19) United States
(12) Patent Application Publication
(10) Pub. No.: US 2023/0057607 A1
(43) Pub. Date: Feb. 23, 2023

(54) ASPHALT COMPOSITION COMPRISING THERMOSETTING REACTIVE COMPOUND

(71) Applicant: BASF SE, Ludwigshafen am Rhein (DE)

(72) Inventors: Brian ORR, Wyandotte, MI (US); Dahlia Ishama CAMPBELL, Wyandotte, MI (US); Bernie Lewis MALONSON, Wyandotte, MI (US)

(21) Appl. No.: 17/793,427

(22) PCT Filed: Jan. 20, 2021
(86) PCT No.: PCT/EP2021/051092

§ 371 Date: Jul. 18, 2022

Related U.S. Application Data
(60) Provisional application No. 62/963,582, filed on Jan. 21, 2020.

(30) Foreign Application Priority Data
Feb. 13, 2020 (EP) 20157071.0

(51) Int. Cl. C08G 18/64; C08G 18/75; C08G 18/76

(52) U.S. Cl. CPC C08G 18/6476; C08G 18/755; C08G 18/758; C08G 18/7621

(57) ABSTRACT

The present invention relates to an asphalt composition comprising a thermosetting reactive compound.

### FIELD OF INVENTION

The present invention relates to an asphalt composition comprising a thermosetting reactive compound.

### BACKGROUND OF THE INVENTION

Generally, asphalt is a colloidal material containing different molecular species classified into asphaltenes and maltenes. Asphalt being viscoelastic and thermoplastic, suffers from property variation over a range of temperatures, i.e. from extreme cold to extreme heat. Asphalt tends to soften in hot weather and crack in extreme cold. At cold temperatures, asphalt becomes brittle and is subject to cracks, while at elevated temperature it softens and loses its physical properties.

The addition of a thermosetting reactive component as binder, in more general terms as modifi-er, allows the physical properties of the asphalt to remain more constant over a range of temperatures and/or improve the physical properties over the temperature range the asphalt is subjected to.

Such modified asphalts are known in the state of the art. However, there is still a need in the asphalt industry for improvement in the asphalt's properties. In part, this is because the current-ly known polymer-modified asphalts have several deficiencies. These include, such as but not limited to, susceptibility to permanent deformation (rutting), flexural fatigue, moisture and de-crease of elasticity at low temperature.

WO 2001/30911 A1 discloses an asphalt composition comprising, by weight based on the total weight of the composition, about 1 to 8%, of a polymeric MDI, wherein the polymeric MDI has a functionality of at least 2.5. It also relates to a process for preparing said asphalt composition by using reaction times of below 2 h. The formation of the product MDI-asphalt is measured by an increase in the product's viscosity or more preferably by dynamic mechanical analysis (DMA).

WO 2001/30912 A1 discloses an aqueous asphalt emulsion comprising, besides asphalt and water, an emulsifiable polyisocyanate. It also relates to an aggregate composition comprising said emulsion, and to a process for preparing said compositions.

WO 2001/30913 A1 discloses an asphalt composition comprising, by weight based on the total weight of the composition, about 1 to 5%, of a polymeric MDI based prepolymer, wherein the polymeric MDI has a functionality of at least 2.5. It also relates to a process for preparing said asphalt composition.

EP 0 537 638 B1 discloses polymer modified bitumen compositions which contain 0.5 to 10 parts by weight of functionalized polyoctenamer to 100 parts by weight of bitumen and, optionally, crosslinking agents characterized in that the polyoctenamer is predominantly a trans-polyoctenamer and contains carboxyl groups, as well as groups derived therefrom for example maleic acid.

The existing asphalt compositions are mostly MDI based and optionally containing additional ingredients. Such compositions have several limitations, for example, limited useful temperature interval (UTI), limited elastic response and low softening points.

It was, therefore, an object of the present invention to provide an asphalt composition having acceptable properties, such as viscosity, functional temperature range, elastic response, useful temperature interval (UTI), non-recoverable creep compliance (Jnr), load rating and deformation during increased traffic levels and reduced speed, stiffness component and resistance to rutting.

### SUMMARY OF THE INVENTION

Surprisingly, it has been found that the above-identified object is met by providing an asphalt composition comprising aliphatic isocyanates or aromatic isocyanates except monomeric MDI or polymeric MDI.

Accordingly, in one aspect, the presently claimed invention is directed to an asphalt composition comprising 0.1 wt. % to 10.0 wt. % of a thermosetting reactive compound selected from an aliphatic isocyanate or an aromatic isocyanate, based on the total weight of the composition, wherein the aromatic isocyanate is not monomeric MDI or polymeric MDI.

In another aspect, the presently claimed invention is directed to a process for preparing the above asphalt composition.

In still another aspect, the presently claimed invention is directed to the use of the above asphalt composition for the preparation of an asphalt mix composition.

### DETAILED DESCRIPTION OF THE INVENTION

Before the present compositions and formulations of the invention are described, it is to be understood that this invention is not limited to particular compositions and formulations described, since such compositions and formulation may, of course, vary. It is also to be understood that the terminology used herein is not intended to be limiting, since the scope of the present invention will be limited only by the appended claims.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment but may. Furthermore, the features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art.

For example, in the appended claims, any of the claimed embodiments can be used in any combination.

Furthermore, the ranges defined throughout the specification include the end values as well, i.e. a range of 1 to 10 implies that both 1 and 10 are included in the range. For the avoidance of doubt, the applicant shall be entitled to any equivalents according to applicable law.

Asphalt Composition

An aspect of the present invention is embodiment 1, directed to an asphalt composition comprising 0.1 wt. % to 10.0 wt. % of a thermosetting reactive compound selected from an aliphatic isocyanate or an aromatic isocyanate, based on the total weight of the composition, wherein the aromatic isocyanate is not monomeric MDI or polymeric MDI.

In another embodiment the presently claimed invention is directed to an asphalt composition comprising 0.1 wt. % to 10.0 wt. % of a thermosetting reactive compound selected from an aliphatic isocyanate or an aromatic isocyanate, based on the total weight of the composition, wherein the aromatic isocyanate is not monomeric MDI or polymeric MDI; and 90 wt. % to 99.9 wt. % of starting asphalt.

An asphalt composition consisting of 0.1 wt. % to 10.0 wt. % of a thermosetting reactive compound selected from an aliphatic isocyanate or an aromatic isocyanate, based on the total weight of the composition, wherein the aromatic isocyanate is not monomeric MDI or polymeric MDI; and 90 wt. % to 99.9 wt. % of starting asphalt; in another embodiment asphalt composition consisting of 0.1 wt. % to 9.0 wt. % of a thermosetting reactive compound selected from an aliphatic isocyanate or an aromatic isocyanate, based on the total weight of the composition, wherein the aromatic isocyanate is not monomeric MDI or polymeric MDI; and 91 wt. % to 99.9 wt. % of starting asphalt; yet another preferred embodiment asphalt composition consisting of 0.1 wt. % to 8.0 wt. % of a thermosetting reactive compound selected from an aliphatic isocyanate or an aromatic isocyanate, based on the total weight of the composition, wherein the aromatic isocyanate is not monomeric MDI or polymeric MDI; and 92 wt. % to 99.9 wt. % of starting asphalt; still another embodiment asphalt composition consisting of 0.1 wt. % to 6.0 wt. % of a thermosetting reactive compound selected from an aliphatic isocyanate or an aromatic isocyanate, based on the total weight of the composition, wherein the aromatic isocyanate is not monomeric MDI or polymeric MDI; and 94 wt. % to 99.9 wt. % of starting asphalt.

Without being bound to this theory, it is presently believed that a specific morphology of the colloid structure is needed to obtain the resulting performance. A thermosetting reactive compound reacts with the phenolic, carboxylic, thiol, anhydride and/or pyrrolic group or any reactive group from the starting asphalt components and links the asphaltenes together, leading to larger parti-cles in the resulting asphalt composition.

In an embodiment, the starting asphalt in the embodiment 1 can be any asphalt known and generally covers any bituminous compound. It can be any of the materials referred to as bitumen or asphalt. For example, distillate, blown, high vacuum, and cut-back bitumen, and for example, asphalt concrete, cast asphalt, asphalt mastic and natural asphalt. In another embodiment, a directly distilled asphalt may be used, having, for example, a penetration of 80/100 or 180/220. In another embodiment, the starting asphalt in the embodiment 1 can be free of fly ash.

The different physical properties of the asphalt composition are measured by different tests and/or standards known in the art and described in detail in the example section.

Elastic response and non-recoverable creep compliance (Jnr) are computed in the multiple stress creep recovery (MSCR) test in which the asphalt is subjected to a constant load for a fixed time. The total deformation for a specific period of time is given in % and corresponds to a measure of the elasticity of the binder. In addition, the phase angle may be measured, which illustrates the improved elastic response (reduced phase angles) of the modified binder.

A bending beam rheometer (BBR) is used to determine the stiffness of asphalt at low temperatures and usually refers to flexural stiffness of the asphalt. Two parameters are determined in this test: creep stiffness, which is a measure of the resistance of the bitumen to constant loading, and the creep rate (or m value), which is a measure of how the asphalt stiffness changes as loads are applied. If the creep stiffness is too high, the asphalt will behave in a brittle manner, and cracking will be more likely. A high m-value is desirable, as the temperature changes and thermal stresses accumulate, the stiffness will change relatively quickly. A high m-value indi-cates that the asphalt will tend to disperse stresses that would otherwise accumulate to a low level, where low temperature cracking could occur.

The term “starting asphalt” refers to a commercially available asphalt prior to reacting with the thermosetting reactive compound according to the present invention.

In one embodiment, the starting asphalt in the embodiment 1 has a penetration selected from 20-30, 30-45, 35-50, 40-60, 50-70, 70-100, 100-150, 160-220, and 250-330, or a performance grade selected from 52-16, 52-22, 52-28, 52-34, 52-40, 58-16, 58-22, 58-28, 58-34, 58-40, 64-16, 64-22, 64-28, 64-34, 64-40, 70-16, 70-22, 70-28, 70-34, 70-40, 76-16, 76-22, 76-28, 76-34 and 76-40. In another embodiment, the penetration is selected from 30-45, 35-50, 40-60, 50-70, 70-100, 100-150, and 160-220, or the performance grade is selected from 52-16, 52-22, 52-28, 52-34, 52-40, 58-16, 58-22, 58-28, 58-34, 58-40, 64-16, 64-22, 64-28, 64-34, 70-16, 70-22, 70-28, 76-16, and 76-22. In yet another embodiment, the penetration is selected from 40-60, 50-70, 70-100, and 100-150, or the performance grade is selected from 52-16, 52-22, 52-28, 52-34, 52-40, 58-16, 58-22, 58-28, 58-34, 64-16, 64-22, 64-28, 70-16, 70-22, 76-16, and 76-22. In a further embodiment, the penetration is selected from 40-60, 50-70, 70-100, and 100-150, or the performance grade is selected from 58-28, 58-34, 64-16, 64-22, 64-28, 70-16, 70-22, 76-16, and 76-22. In still a further embodiment, the starting asphalt has the performance grade selected from 70-16, 70-22, 64-16, and 64-22. AASHTO-M320 describes the standard specification for performance graded asphalts.

According to the present invention, the amount of the starting asphalt in the embodiment 1 is in the range between 90 wt. % to 99.9 wt. %, based on the total weight of the asphalt composition.

In another embodiment, this amount is in between 90 wt. % to 99.8 wt. %, or in between 91 wt. % to 99.8 wt. %, or in between 91 wt. % to 99.7 wt. %. In yet another embodiment, this amount is in between 92 wt. % to 99.7 wt. %, or in between 92 wt. % to 99.6 wt. %, or in between 93 wt. % to 99.6 wt. %. In a further embodiment, this amount is in between 93 wt. % to 99.5 wt. %, or in between 94 wt. % to 99.5 wt. %, or in between 94 wt. % to 99.4 wt. %. In a still further embodiment, this amount is in between 95 wt. % to 99.4 wt. %, or in between 95 wt. % to 99.3 wt. %, or in between 95 wt. % to 99.2 wt. %, or in between 95 wt. % to 99.1 wt. %. In another embodiment, this amount is in between 95.1 wt. % to 99.1 wt. %, or in between 99.2 wt. % to 99.1 wt. %, or in between 95.3 wt. % to 99.1 wt. %, or in between 95.4 wt. % to 99.1 wt. %.

Generally, the starting asphalt from different suppliers differ in terms of their composition depending on which reservoir the crude oil is from, as well as the distillation process at the refiner-ies. However, the cumulated total amount of reactive group is in the range of from 3.1 to 4.5 mg KOH/g.

Thermosetting Reactive Compound

Generally, the thermosetting reactive compounds react chemically with different molecular species classified into asphaltene and maltenes of the respective starting asphalt grade, and help to generate a specific morphology of colloid structures resulting in physical properties of the asphalt to remain more constant over a broad range of temperatures and/or even improve the physical properties over the temperature range the asphalt is subjected to.

In one embodiment, the thermosetting reactive compound in the embodiment 1 can be selected from an aliphatic isocyanate or an aromatic isocyanate. Aromatic isocyanates include those in which two or more of the isocyanato groups are attached directly and/or indirectly to the aromatic ring, except monomeric MDI or polymeric MDI. Further, it is to be understood here that the isocyanate includes both monomeric and polymeric forms of the aliphatic or aromatic isocyanates. By the term “polymeric”, it is referred to the polymeric grade of the aliphatic or aromatic isocyanate comprising different oligomers and homologues.

In one embodiment, the thermosetting reactive compound in the embodiment 1 is an aliphatic isocyanate. Suitable aliphatic isocyanates can be selected from cyclobutane-1,3-diisocyanate, 1,2-, 1,3- and 1,4-cyclohexane diisocyanate, 2,4- and 2,6 methylcyclohexane diisocyanate, 4,4′-and 2,4′-dicyclohexyldiisocyanate, 1,3,5-cyclohexane triisocyanate, isocyanatomethylcyclohexane isocyanate, isocyanatoethylcyclohexane isocyanate, bis(isocyanatomethyl)cyclohexane diisocyanate, 4,4′- and 2,4′-bis(isocyanato-methyl) dicyclohexane, isophorone diisocyanate (IPDI), diisocyanatodicyclo-hexylmethane (H12MDI), tetramethylene 1,4-diisocyanate, pentamethylene 1,5-diisocyanate, hexamethylene 1,6-diisocyanate (HDI), decamethylene diisocyanate, 1,12-dodecane diisocyanate, 2,2,4-trimethyl-hexamethylene diisocyanate, 2,4,4-trimethyl-hexamethylene diisocyanate, and 2-methyl-1,5-pentamethylene diisocyanate.

In another embodiment, the aliphatic isocyanate in the embodiment 1 is selected from 1,3,5-cyclohexane triisocyanate, isocyanatomethylcyclohexane isocyanate, isocyanatoethylcyclohexane isocyanate, bis(isocyanatomethyl)cyclohexane diisocyanate, 4,4′- and 2,4′-bis(isocyanato-methyl) dicyclohexane, isophorone diisocyanate (IPDI), diisocyanatodicyclo-hexylmethane (H12MDI), tetramethylene 1,4-diisocyanate, pentamethylene 1,5-diisocyanate, hexamethylene 1,6-diisocyanate (HDI), decamethylene diisocyanate, 1,12-dodecane diisocyanate, 2,2,4-trimethyl-hexamethylene diisocyanate, 2,4,4-trimethyl-hexamethylene diisocyanate, and 2-methyl-1,5-pentamethylene diisocyanate.

In yet another embodiment, the aliphatic isocyanate in the embodiment 1 is selected from isophorone diisocyanate (IPDI), diisocyanatodicyclo-hexylmethane (H12MDI), tetramethylene 1,4-diisocyanate, pentamethylene 1,5-diisocyanate, hexamethylene 1,6-diisocyanate (HDI), decamethylene diisocyanate, 1,12-dodecane diisocyanate, 2,2,4-trimethyl-hexamethylene diisocyanate, 2,4,4-trimethyl-hexamethylene diisocyanate, and 2-methyl-1,5-pentamethylene diisocyanate.

In a further embodiment, the aliphatic isocyanate in the embodiment 1 is selected from isophorone diisocyanate (IPDI), diisocyanatodicyclo-hexylmethane (H12MDI), and hexamethylene 1,6-diisocyanate (HDI).

In another embodiment, the thermosetting reactive compound in the embodiment 1 is an aromatic isocyanate. Suitable aromatic isocyanates can be selected from toluene diisocyanate, polymeric toluene diisocyanate, m-phenylene diisocyanate; 1,5-naphthalene diisocyanate; 1,3-phenylene diisocyanate; 2,4,6-toluylene triisocyanate, 1,3-diisopropylphenylene-2,4-diisocyanate; 1-methyl-3,5-diethylphenylene-2,4-diisocyanate; 1,3,5-triethylphenylene-2,4-diisocyanate; 1,3,5-triisoproply-phenylene-2,4-diisocyanate; 3,3′-diethyl-bisphenyl-4,4′-diisocyanate; 3,5,3′,5′-tetraethyl-diphenylmethane-4,4′-diisocyanate; 3,5,3′5-tetraisopropyldiphenylmethane-4,4′-diisocyanate; 1-ethyl-4-ethoxy-phenyl-2,5-diisocyanate; 1,3,5-triethyl benzene-2,4,6-triisocyanate; 1-ethyl-3,5-diisopropyl ben-zene-2,4,6-triisocyanate, tolidine diisocyanate, and 1,3,5-triisopropyl benzene-2,4,6-triisocyanate.

In yet another embodiment, the aromatic isocyanate in the embodiment 1 is selected from toluene diisocyanate, polymeric toluene diisocyanate, m-phenylene diisocyanate; 1,5-naphthalene diisocyanate; 1,3-phenylene diisocyanate; 2,4,6-toluylene triisocyanate, 1,3-diisopropylphenylene-2,4-diisocyanate; 1-methyl-3,5-diethylphenylene-2,4-diisocyanate; 1,3,5-triethylphenylene-2,4-diisocyanate; 1,3,5-triisoproply-phenylene-2,4-diisocyanate; 3,3′-diethyl-bisphenyl-4,4′-diisocyanate; 3,5,3′,5′-tetraethyl-diphenylmethane-4,4′-diisocyanate; 3,5,3%5′-tetraisopropyldiphenylmethane-4,4′-diisocyanate; and 1-ethyl-4-ethoxy-phenyl-2,5-diisocyanate.

In a further embodiment, the aromatic isocyanate in the embodiment is selected from toluene diisocyanate, polymeric toluene diisocyanate, m-phenylene diisocyanate; 1,5-naphthalene diisocyanate; 1,3-phenylene diisocyanate; 2,4,6-toluylene triisocyanate, 1,3-diisopropylphenylene-2,4-diisocyanate; 1-methyl-3,5-diethylphenylene-2,4-diisocyanate; 1,3,5-triethylphenylene-2,4-diisocyanate; and 1,3,5-triisoproply-phenylene-2,4-diisocyanate.

In a still further embodiment, the aromatic isocyanate in the embodiment 1 is selected from toluene diisocyanate, polymeric toluene diisocyanate, and 1,5-naphthalene diisocyanate.

In the present context, the aromatic isocyanate in the embodiment 1 does not contain monomeric MDI or polymeric MDI. By MDI, it is referred to methylene diphenyl diisocyanate and all isomers thereof.

According to the present invention, the amount of the thermosetting reactive compound in the embodiment 1 is in the range between 0.1 wt. % to 10.0 wt. %, based on the total weight of the asphalt composition. In another embodiment, this amount is in between 0.2 wt. % to 10.0 wt. %, or in between 0.2 wt. % to 9.0 wt. %, or in between 0.3 wt. % to 9.0 wt. %. In yet another embodiment, this amount is in between 0.3 wt. % to 8.0 wt. %, or in between 0.4 wt. % to 8.0 wt. %, or in between 0.4 wt. % to 7.0 wt. %. In a further embodiment, this amount is in between 0.5 wt. % to 7.0 wt. %, or in between 0.5 wt. % to 6.0 wt. %, or in between 0.6 wt. % to 6.0 wt. %. In a still further embodiment, this amount is in between 0.6 wt. % to 5.0 wt. %, or in between 0.7 wt. % to 5.0 wt. %, or in between 0.8 wt. % to 5.0 wt. %, or in between 0.9 wt. % to 5.0 wt. %. In another embodiment, this amount is in between 0.9 wt. % to 4.9 wt. %, or in between 0.9 wt. % to 4.8 wt. %, or in between 0.9 wt. % to 4.7 wt. %, or in between 0.9 wt. % to 4.6 wt. %.

In an embodiment, the amount of the thermosetting reactive compound in the embodiment 1 depends on the composition of the respective starting asphalt. For hard starting asphalt having a needle penetration below 85, less thermosetting reactive compound is needed and for soft starting asphalt having a needle penetration above 85, a larger amount of the thermosetting reactive compound is required. Without being bound to this theory, it is presently believed that the amount of the thermosetting reactive compound needs to be readjusted due to the different concentration of polar components (which include asphaltene), also called n-heptane insoluble, in different asphalts. In soft starting asphalts, which corresponds to a needle penetration above 85, asphaltenes are diluted, hence lower concentrated, which require a larger amount of the thermosetting reactive compound and more oxidation, which can be supplied by the oxygen atmosphere of the preparation process of an asphalt composition, to achieve better performance.

In another embodiment, the asphalt composition of the embodiment 1 does not contain any granular material selected from gravel, reclaimed asphalt pavement, sand and filler material.

In yet another embodiment, the asphalt composition of the embodiment 1 does not contain a polymer selected from styrene/butadiene/styrene copolymer (SBS), styrene butadiene rubber (SBR), neoprene, polyethylene, low density polyethylene, oxidized high density polyethylene, polypropylene, oxidized high density polypropylene, maleated polypropylene, ethylene-butyl-acrylate-glycidyl-methacrylate terpolymer, ethyl vinyl acetate (EVA), and polyphosphoric acid (PPA)

In another embodiment, the asphalt composition of the embodiment 1 further comprises other thermosetting reactive compounds, such as but not limited to, epoxy resins and melamine formaldehyde resins.

Generally, epoxy resins are known in the art. In one embodiment, the asphalt composition in the embodiment 1 optionally comprises one or more aromatic epoxy resins and/or cycloaliphatic epoxy resins. Suitable epoxy resins can be selected from bisphenol A bisglycidyl ether (DGE-BA), bisphenol F bisglycidyl ether, ring-hydrogenated bisphenol A bisglycidyl ether, ring-hydrogenated bisphenol F bisglycidyl ether, bisphenol S bisglycidyl ether (DGEBS), tetraglyc-idylmethylenedianiline (TGMDA), epoxy novolaks (the reaction products from epichlorohydrin and phenolic resins (novolak)), cycloaliphatic epoxy resins, such as, 3,4-epoxycyclohexylmethyl, 3,4-epoxycylcohexanecarboxylate and diglycidyl hexahydrophthalate.

Melamine formaldehyde resins are mainly the condensation product of melamine and formaldehyde. Depending on the desired application, they can be modified, for example, by reaction with polyvalent alcohols. In one embodiment, the melamine formaldehyde resins relate to an aqueous melamine resin mixture with a resin content in the range of 50 wt. % to 70 wt. %, based on the aqueous melamine resin mixture, with melamine and formaldehyde present in the resin in a molar ratio ranging between 1.0:3.0 to 1.0:1.0.

In another embodiment, the melamine formaldehyde may contain 1 to 10 wt. % of polyvalent alcohols, for example, diethylene glycol, propylene glycol, butylene glycol, pentane diol and hexane diol. As further additives, the melamine formaldehyde resins may contain less than 8 wt. % caprolactam and 0.5 to 10 wt. % 2-(2-phenoxyethoxy)-ethanol and/or polyethylene glycol with an average molecular mass of 200 to 1500 g/mol, with each wt. % based on the aqueous melamine resin mixture.

In yet another embodiment, the asphalt composition of the embodiment 1 further comprises additives. Generally known additives for asphalt composition are known to the person skilled in the art and may be added in the embodiment 1 to adapt the properties of the asphalt composition depending on the respective application. Additives may be, for example, waxes. These waxes if used as additives in the asphalt composition of the embodiment, may be functionalized or synthetic waxes, or naturally occurring waxes. Furthermore, the wax may be oxidized or non-oxidized. Non-exclusive examples of synthetic waxes include ethylene bis-stearamide wax (EBS), Fischer-Tropsch wax (FT), oxidized Fischer-Tropsch wax (FTO), polyolefin waxes such as polyethylene wax (PE), oxidized polyethylene wax (OxPE), polypropylene wax, polypropyl-ene/polyethylene wax, alcohol wax, silicone wax, petroleum waxes such as microcrystalline wax or paraffin, and other synthetic waxes. Non-exclusive examples of functionalized waxes include amine waxes, amide waxes, ester waxes, carboxylic acid waxes, and microcrystalline waxes. Naturally occurring waxes may be derived from a plant, from an animal, or from a mineral, or from other sources. Non-exclusive examples of natural waxes include plant waxes such as can-delilla wax, carnauba wax, rice wax, Japan wax and jojoba oil; animal waxes such as beeswax, lanolin and whale wax; and mineral waxes such as montan wax, ozokerit and ceresin. Mixtures of the aforesaid waxes are also suitable, such as, for example, the wax may include a blend of a Fischer-Tropsch (FT) wax and a polyethylene wax.

Plasticizers may also be used as additives, in conventional amounts, to increase the plasticity or fluidity of the asphalt composition of embodiment 1. Suitable plasticizers include hydrocarbon oils (e.g. paraffin, aromatic and naphthenic oils), long chain carbon diesters (e.g. phthalic acid esters, such as dioctyl phthalate, and adipic acid esters, such as dioctyl adipate), sebacic acid esters, glycol, fatty acid, phosphoric and stearic esters, epoxy plasticizers (e.g. epoxidized soy-bean oil), polyether and polyester plasticizers, alkyl monoesters (e.g. butyl oleate), long chain partial ether esters (e.g. butyl cellosolve oleate) among other plasticizers.

In one embodiment, the asphalt composition of the embodiment 1 contains 0.1 wt. % to 10.0 wt. % of the thermosetting reactive compound selected from the aliphatic isocyanate or the aromatic isocyanate, based on the total weight of the composition, wherein the aromatic isocyanate is not monomeric MDI or polymeric MDI.

The asphalt composition of the embodiment 1, as described herein, has acceptable properties, such as, viscosity, functional temperature range, elastic response, useful temperature interval (UTI), non-recoverable creep compliance (Jnr), load rating and deformation during increased traffic levels and reduced speed, stiffness component and resistance to rutting, which render it useful for various applications, such as but not limited to, paints and coatings, mastics for filling joints and sealing cracks, grouts and hot-poured surfaces, in admixture with stone to provide aggregates, hot coatings for surfacing, surface coatings for surfacing, warm mix asphalt and hot mix asphalt.

Process

Another aspect of the present invention is embodiment 2, directed to a process for preparing the asphalt composition of the embodiment 1, said process comprising the steps of:
(A) heating the starting asphalt to a temperature ranging between 110° C. to 190° C.,
(B) adding 0.1 wt. % to 10.0 wt. % of the thermosetting reactive compound to the starting asphalt of step (A), based on the total weight of the asphalt composition, to obtain a reaction mixture, and
(C) stirring the reaction mixture of step (B) at a temperature ranging between 110° C. to 190° C. for at least 2.5 h under an oxygen atmosphere.

In one embodiment, the temperature in step (A) and/or step (B) in the embodiment 2, independent of each other, is in the range between 110° C. to 180° C., or in between 110° C. to 160° C., or in between 110° C. to 150° C.

In another embodiment, the thermosetting reactive compound in the step (B) is added under stirring. A suitable amount of the thermosetting reactive compound in the embodiment 2 may also be determined by potentiometric titration, wherein the amount of reactive groups in the starting asphalt is determined and correlated to the equivalent weight of the reactive groups of the thermosetting reactive compound.

In one embodiment, the step (C) is performed after step (B) in the embodiment 2. The reaction mixture is stirred at a temperature in the range of from 110 to 190° C. for at least 2.5 h, or at least 3 h, or even at least 4 h. The mixing time can be up to 20 h, or not more than 15 h, or even less than 12 h.

In another embodiment, an oxygen atmosphere is maintained in the embodiment 2. In one embodiment, the oxygen concentration is in the range between 1 vol.-% to 21 vol.-%, or in between 5 vol.-% to 21 vol.-%, or in between 10 vol.-% to 21 vol.-%.

In yet another embodiment, the preparation of the asphalt composition in the embodiment 2 is carried out under stirring to allow an intensive mixing of the starting asphalt with the thermosetting reactive compound and to maximize the contact with oxygen. In one embodiment, the stirring energy is in the range of 1 W/I to 14 W/1, or in the range of 2 W/I to 12 W/1, or even in the range of 4 W/I to 10 W/1.

Generally, the process of the embodiment 2 is not limited to be performed in one reaction vessel, for example a container. The respective starting asphalt may be reacted with the thermosetting reactive compound in a first step under the conditions described above. The asphalt composition can be then cooled down, transferred to a different reaction vessel subsequent to the transfer heated up so that the total reaction time under oxygen is at least 2.5 h. The steps (A) and (B) (the first step) in the embodiment 2 are such that the reaction mixture is homogenized and the reaction between the reactive groups of the starting asphalt with the reactive groups of the thermosetting reactive compound is induced. The thermosetting reactive compound may be loaded on the asphaltene surfaces. The second or additional heating step, referred to as step (C), is to support cross linking reaction by oxidation.

Another aspect of the present invention is embodiment 3, directed towards the use of the asphalt composition of the embodiment 1 or as obtained from the embodiment 2, for the preparation of an asphalt mix composition.

In one embodiment, the asphalt mix composition in the embodiment 3 is selected from the following:
paints and coatings, particularly for waterproofing,
mastics for filling joints and sealing cracks,
grouts and hot-poured surfaces for surfacing of roads, aerodromes, sports grounds, etc.,
in admixture with stone to provide aggregates (comprising about 5-20% of the asphalt composition), e.g. asphalt mix,
asphalt emulsion,
hot coatings for surfacing as above,
surface coatings for surfacing,
warm mix asphalt, and
hot mix asphalt.

Illustrative embodiments of the present invention are listed below, but do not restrict the present invention. In particular, the present invention also encompasses those embodiments that result from the dependency references and hence combinations specified hereinafter. More particularly, in the case of naming of a range of embodiments hereinafter, for example the expression

“The process according to any of embodiments 1 to 4”, should be understood such that any combination of the embodiments within this range is explicitly disclosed to the person skilled in the art, meaning that the expression should be regarded as being synonymous to “The process according to any of embodiments 1, 2, 3 and 4”:

I. An asphalt composition comprising 0.1 wt. % to 10.0 wt. % of a thermosetting reactive compound selected from an aliphatic isocyanate or an aromatic isocyanate, based on the total weight of the composition, wherein the aromatic isocyanate is not monomeric MDI or polymeric MDI.

II. The asphalt composition according to embodiment I, wherein the thermosetting reactive compound is present in an amount in between 1.0 wt. % to 5.0 wt. %, based on the total weight of the composition.

III. The asphalt composition according to embodiment I or II, wherein the starting asphalt has a performance grade selected from 52-16, 52-22, 52-28, 52-34, 52-40, 58-16, 58-22, 58-28, 58-34, 58-40, 64-16, 64-22, 64-28, 64-34, 64-40, 70-16, 70-22, 70-28, 70-34, 70-40, 76-16, 76-22, 76-28, 76-34, and 76-40, determined according to AASHTO-M320.

IV. The asphalt composition according to one or more of embodiments I to III, wherein the starting asphalt has a performance grade selected from 58-28, 58-34, 64-16, 64-22, 64-28, 70-16, 70-22, 76-16 and 76-22, determined according to AASHTO-M320.

V. The asphalt composition according to one or more of embodiments I to IV, wherein the aliphatic isocyanate is selected from cyclobutane-1,3-diisocyanate, 1,2-, 1,3- and 1,4-cyclohexane diisocyanate, 2,4- and 2,6 methylcyclohexane diisocyanate, 4,4′- and 2,4′-dicyclohexyldiisocyanate, 1,3,5-cyclohexane triisocyanate, isocyanatomethylcyclohexane isocyanate, isocyanatoethylcyclohexane isocyanate, bis(isocyanatomethyl)cyclohexane diisocyanate, 4,4′- and 2,4′-bis(isocyanato-methyl) dicyclohexane, isophorone diisocyanate (IPDI), diisocya-natodicyclo-hexylmethane (H12MDI), tetramethylene 1,4-diisocyanate, pentamethylene 1,5-diisocyanate, hexamethylene 1,6-diisocyanate (HDI), decamethylene diisocyanate, 1,12-dodecane diisocyanate, 2,2,4-trimethyl-hexamethylene diisocyanate, 2,4,4-trimethyl-hexamethylene diisocyanate, and 2-methyl-1,5-pentamethylene diisocyanate.

VI. The asphalt composition according to one or more of embodiments I to V, wherein the aliphatic isocyanate is selected from isophorone diisocyanate (IPDI), diisocyanatodicyclo-hexylmethane (H12MDI), and hexamethylene 1,6-diisocyanate (HDI).

VII. The asphalt composition according to one or more of embodiments I to VI, wherein the aromatic isocyanate is selected from toluene diisocyanate, polymeric toluene diisocyanate, m-phenylene diisocyanate; 1,5-naphthalene diisocyanate; 1,3-phenylene diisocyanate; 2,4,6-toluylene triisocyanate, 1,3-diisopropylphenylene-2,4-diisocyanate; 1-methyl-3,5-diethylphenylene-2,4-diisocyanate; 1,3,5-triethylphenylene-2,4-diisocyanate; 1,3,5-triisoproply-phenylene-2,4-diisocyanate; 3,3′-diethyl-bisphenyl-4,4′-diisocyanate; 3,5,3′5-tetraethyl-diphenylmethane-4,4′-diisocyanate; 3,5,3′,5′-tetraisopropyldiphenylmethane-4,4′-diisocyanate; 1-ethyl-4-ethoxy-phenyl-2,5-diisocyanate; 1,3,5-triethyl benzene-2,4,6-triisocyanate; 1-ethyl-3,5-diisopropyl ben-zene-2,4,6-triisocyanate, tolidine diisocyanate, and 1,3,5-triisopropyl benzene-2,4,6-triisocyanate.

VIII. The asphalt composition according to one or more of embodiments I to VII, wherein the aromatic isocyanate is selected from toluene diisocyanate, polymeric toluene diisocyanate, and 1,5-naphthalene diisocyanate.

IX. The asphalt composition according to one or more of embodiments I to VIII, wherein the starting asphalt has a performance grade of 64-22, determined according AASHTO-M320.

X. The asphalt composition according to one or more of embodiments I to IX, wherein the asphalt composition does not contain any granular material selected from gravel, reclaimed asphalt pavement, sand and filler material.

XI. A process for preparing an asphalt composition according to one or more of embodiments I to X, said process comprising the steps of:
(A) heating the starting asphalt to a temperature ranging between 110° C. to 190° C.,
(B) adding 0.1 wt. % to 10.0 wt. % of the thermosetting reactive compound to the starting asphalt of step (A), based on the total weight of the asphalt composition, to obtain a reaction mixture, and
(C) stirring the reaction mixture of step (B) at a temperature ranging between 110° C. to 190° C. for at least 2.5 h under an oxygen atmosphere.

XII. The process according to embodiment XI, wherein the temperature in step (A) and (B), independent of each other, is in the range of 110° C. to 150° C.

XIII. The process according to embodiment XI or XII, wherein the stirring in step (C) is carried out for at least 4 h.

XIV. Use of the composition according to one or more of embodiments I to X or as obtained according to one or more of embodiments XI to XIII for the preparation of an asphalt mix composition.

### Examples

The presently claimed invention is illustrated by the non-restrictive examples which are as fol-lows:

TABLE 1
Examples of asphalt compositions according
to the present invention

| | |
|---|---|
| A1 | Asphalt having performance grade of 64-22 according to AASHTO - |
| | M320 with 3.0 wt. % to 4.0 wt. % of toluene diisocyanate (TDI) |
| A2 | Asphalt having performance grade of 64-22 according to AASHTO - |
| | M320 with 3.0 wt. % to 4.0 wt. % of 1,5-naphthalene diisocyanate |
| | (NDI) |
| A3 | Asphalt having performance grade of 64-22 according to AASHTO - |
| | M320 with 3.0 wt. % to 4.0 wt. % of hexamethylene 1,6-diisocyanate |
| | (HDI) |
| A4 | Asphalt having performance grade of 64-22 according to AASHTO - |
| | M320 with 3.5 wt. % to 4.5 wt. % of isophorone diisocyanate (IPDI) |
| A5 | Asphalt having performance grade of 64-22 according to AASHTO - |
| | M320 with 3.0 wt. % to 4.0 wt. % of diisocyanatodicyclo- |
| | hexylmethane (H12MDI) |
| A6 | Asphalt having performance grade of 64-22 according to AASHTO - |
| | M320 with 0.9 wt. % to 2.0 wt. % of TDI |
| A7 | Asphalt having performance grade of 64-22 according to AASHTO - |
| | M320 with 0.9 wt. % to 2.0 wt. % of IPDI |

Asphalt Tests

Softening point DIN EN1427

Two horizontal disks of bitumen, cast in shouldered brass rings, are heated at a controlled rate in a liquid bath while each supports a steel ball. The softening point is reported as the mean of the temperatures at which the two disks soften enough to allow each ball, enveloped in bitumen, to fall a distance of (25±0,4) [mm].

Rolling Thin Film Oven (RTFO) Test DIN EN 12607-1

Bitumen is heated in bottles in an oven for 85 [min] at 163 [° C.]. The bottles are rotated at 15 [rpm] and heated air is blown into each bottle at its lowest point of travel at 4000 [mL/min]. The effects of heat and air are determined from changes in physical test values as measured before and after the oven treatment.

Dynamic Shear Rheometer (DSR) DIN EN 14770— ASTM D7175

A dynamic shear rheometer test system consists of parallel plates, a means for controlling the temperature of the test specimen, a loading device, and a control and data acquisition system.

Multiple Stress Creep Recovery Test DIN EN 16659— ASTM D7405

This test method is used to determine the presence of elastic response in an asphalt binder under shear creep and recover at two stress level (0.1 and 3.2 [kPa]) and at a specified temperature (50 [° C.]). This test uses the DSR to load a 25 [mm] at a constant stress for 1 [s], and then al-lowed to recover for 9 [s]. Ten creep and recovery cycles are run at 0.100 [kPa] creep stress followed by ten cycles at 3.200 [kPa] creep stress.

Potentiometric titration method for determining reactive groups in an asphalt:

Acid Value Approx. 0.5-1 g sample was dissolved in 50 ml toluene and titrated potentiometrically with 0.1 mol/1 tetrabutylammonium hydroxide solution. A few drops of water can be added to the titration solution to ensure sufficient conductivity. A blank value was determined as well.

Base Value Approx. 0.5-1 g sample was dissolved in 50 ml toluene and titrated potentiometrically with 0.1 mol/1 trifluoromethane sulfonic acid solution. A few drops of water can be added to the titration solution to ensure sufficient conductivity. A blank value was determined as well.

### Examples and Comparative Examples

Procedure for the Preparation of Asphalt Composition

For inventive example 1 (A1), 2.5 kg of asphalt having performance grade 64-22 was heated up to 150° C. under oxygen atmosphere and stirred at 600 rpm in a heating mantle (temperature set up to 150° C.). 95.75 g of the TDI (3.83 wt.-%) was then added to the melted asphalt. The reaction was further stirred at 150° C. for 2 h before being cooled down at room temperature.

For inventive example 2 (A2), 2.5 kg of asphalt having performance grade 64-22 was heated up to 150° C. under oxygen atmosphere and stirred at 600 rpm in a heating mantle (temperature set up to 150° C.). 96 g of the NDI (3.84 wt.-%) was then added to the melted asphalt. The reaction was further stirred at 150° C. for 2 h before being cooled down at room temperature.

For inventive example 3 (A3), 2.5 kg of asphalt having performance grade 64-22 was heated up to 150° C. under oxygen atmosphere and stirred at 600 rpm in a heating mantle (temperature set up to 150° C.). 98.50 g of the HDI (3.94 wt.-%) was then added to the melted asphalt. The reaction was further stirred at 150° C. for 2 h before being cooled down at room temperature.

For inventive example 4 (A4), 2.5 kg of asphalt having performance grade 64-22 was heated up to 150° C. under oxygen atmosphere and stirred at 600 rpm in a heating mantle (temperature set up to 150° C.). 100 g of the IPDI (4.0 wt.-%) was then added to the melted asphalt. The reaction was further stirred at 150° C. for 2 h before being cooled down at room temperature.

For inventive example 5 (A5), 2.5 kg of asphalt having performance grade 64-22 was heated up to 150° C. under oxygen atmosphere and stirred at 600 rpm in a heating mantle (temperature set up to 150° C.). 95 g of the H12MDI (3.8 wt.-%) was then added to the melted asphalt. The reaction was further stirred at 150° C. for 2 h before being cooled down at room temperature.

For inventive example 6 (A6), 2.5 kg of asphalt having performance grade 64-22 was heated up to 150° C. under oxygen atmosphere and stirred at 600 rpm in a heating mantle (temperature set up to 150° C.). 25 g of the TDI (1.0 wt.-%) was then added to the melted asphalt. The reaction was further stirred at 150° C. for 2 h before being cooled down at room temperature.

For inventive example 7 (A7), 2.5 kg of asphalt having performance grade 64-22 was heated up to 150° C. under oxygen atmosphere and stirred at 600 rpm in a heating mantle (temperature set up to 150° C.). 25 g of the IPDI (1.0 wt.-%) was then added to the melted asphalt. The reaction was further stirred at 150° C. for 2 h before being cooled down at room temperature.

Comparative example 1 (CE 1) was unmodified asphalt having performance grade 64-22.

TABLE 2
Properties of inventive and comparative asphalt compositions

| Properties | A1 | A2 | A3 | A4 | A5 | A6 | A7 | CE 1 |
|---|---|---|---|---|---|---|---|---|
| Performance | 70-16 | 70-16 | 64-22 | 64-16 | 64-16 | 70-22 | 70-22 | 64-22 |
| grade | | | | | | | | |
| UTI (° C.) | 92.5 | 96.3 | 89.1 | 88.4 | 87.4 | 94.6 | 97.2 | 92.7 |

RTFO MSCR at 58° C.

| | | | | | | | | |
|---|---|---|---|---|---|---|---|---|
| % recovery | 34.3 | 78 | 24.1 | 14.7 | 10.4 | 18.74 | 28.37 | 5.3 |
| at 0.1 kPa | | | | | | | | |
| % recovery | 15.5 | 34.3 | 11.3 | 7.1 | 3.4 | 3.65 | 3.85 | 1.1 |
| at 3.2 kPa | | | | | | | | |
| Jnr at | 0.372 | 0.048 | 0.708 | 0.846 | 1.354 | 0.922 | 0.880 | 2.195 |
| 0.1 kPa | | | | | | | | |
| Jnr at | 0.507 | 0.149 | 0.873 | 0.965 | 1.562 | 1.229 | 1.372 | 2.461 |
| 3.2 kPa | | | | | | | | |

TEST ON UNAGED MATERIAL

| | | | | | | | | |
|---|---|---|---|---|---|---|---|---|
| Brookfield | 555 | 1365 | 432 | 450 | 422 | 618 | 978 | 435 |
| viscosity | | | | | | | | |
| (mPa · s) | | | | | | | | |
| @135° C. | | | | | | | | |
| Phase angle | 85.8 | 81.7 | 87.7 | 87.7 | 87.8 | 86.1 | 82.7 | 87.9 |
| (delta) | | | | | | | | |
| @70° C. | | | | | | | | |
| G*/sin delta | 1.15 | 1.88 | 0.57 | 0.72 | 0.67 | 1.18 | 1.33 | 0.68 |
| at 10 rad/s | | | | | | | | |
| (70° C.), kPa | | | | | | | | |

TEST ON RTFO RESIDUE

| | | | | | | | | |
|---|---|---|---|---|---|---|---|---|
| Phase angle | 77.4 (at | 72.9 (at | 77.4 (at | 80.1 (at | 82.1 (at | 80.7 | 80.4 | 87.9 (at |
| (delta) | 76° C.) | 82° C.) | 70° C.) | 70° C.) | 70° C.) | | | 70° C.) |
| G*/sin delta | 2.93 (at | 3.37 (at | 3.96 (at | 3.82 (at | 2.62 (at | 3.38 | 3.13 | 1.81 (at |
| at 10 rad/s, | 76° C.) | 82° C.) | 70° C.) | 70° C.) | 70° C.) | | | 70° C.) |
| kPa | | | | | | | | |

BENDING BEAM RHEOMETER

| | | | | | | | | |
|---|---|---|---|---|---|---|---|---|
| Creep stiffness | 176 | 175 | 157 | 186 | 178 | 203 | 188 | 152 |
| (at −12° C.), | | | | | | | | |
| 60 s, MPa | | | | | | | | |

When compared with CE 1, the present invention asphalt compositions (A1 to A7) result in increased rheological property (refer Brookfield viscosity), increased elastic response (refer re-duction in % recovery at 3.2 kPa), increased stiffness (refer increase in Jnr values at 3.2 kPa), increased cracking resistance (refer increase in creep stiffness values) and acceptable UTI values.

1.-14. (canceled)

15. An asphalt composition comprising 0.1 wt. % to 10.0 wt. % of a thermosetting reactive compound selected from an aliphatic isocyanate or an aromatic isocyanate, based on the total weight of the composition, wherein the aromatic isocyanate is not monomeric MDI or polymeric MDI.

16. The asphalt composition according to claim 15, wherein the thermosetting reactive compound is present in an amount in between 1.0 wt. % to 5.0 wt. %, based on the total weight of the composition.

17. The asphalt composition according to claim 15, wherein the starting asphalt has a performance grade selected from 52-16, 52-22, 52-28, 52-34, 52-40, 58-16, 58-22, 58-28, 58-34, 58-40, 64-16, 64-22, 64-28, 64-34, 64-40, 70-16, 70-22, 70-28, 70-34, 70-40, 76-16, 76-22, 76-28, 76-34, and 76-40, determined according to AASHTO-M320.

18. The asphalt composition according to claim 15, wherein the starting asphalt has a performance grade selected from 58-28, 58-34, 64-16, 64-22, 64-28, 70-16, 70-22, 76-16 and 76-22, determined according to AASHTO-M320.

19. The asphalt composition according to claim 15, wherein the aliphatic isocyanate is selected from cyclobutane-1,3-diisocyanate, 1,2-, 1,3- and 1,4-cyclohexane diisocyanate, 2,4-and 2,6 methylcyclohexane diisocyanate, 4,4′- and 2,4′-dicyclohexyldiisocyanate, 1,3,5-cyclohexane triisocyanate, isocyanatomethylcyclohexane isocyanate, isocyanatoethylcyclohexane isocyanate, bis(isocyanatomethyl)cyclohexane diisocyanate, 4,4′-and 2,4′-bis(isocyanato-methyl) dicyclohexane, isophorone diisocyanate (IPDI), diisocyanatodicyclo-hexylmethane (H12MDI), tetramethylene 1,4-diisocyanate, pentamethylene 1,5-diisocyanate, hexamethylene 1,6-diisocyanate (HDI), decamethylene diisocyanate, 1,12-dodecane diisocyanate, 2,2,4-trimethyl-hexamethylene diisocyanate, 2,4,4-trimethyl-hexamethylene diisocyanate, and 2-methyl-1,5-pentamethylene diisocyanate.

20. The asphalt composition according to claim 15, wherein the aliphatic isocyanate is selected from isophorone diisocyanate (IPDI), diisocyanatodicyclo-hexylmethane (H12MDI), and hexamethylene 1,6-diisocyanate (HDI).

21. The asphalt composition according to claim 15, wherein the aromatic isocyanate is selected from toluene diisocyanate, polymeric toluene diisocyanate, m-phenylene diisocyanate; 1,5-naphthalene diisocyanate; 1,3-phenylene diisocyanate; 2,4,6-toluylene triisocyanate, 1,3-diisopropylphenylene-2,4-diisocyanate; 1-methyl-3,5-diethylphenylene-2,4-diisocyanate; 1,3,5-triethylphenylene-2,4-diisocyanate; 1,3,5-triisoproply-phenylene-2,4-diisocyanate; 3,3 ‘-diethyl-bisphenyl-4,4’-diisocyanate; 3,5,3 ‘,5’-tetraethyl-diphenylmethane-4,4′-diisocyanate; 3,5,3 ‘,5’-tetraisopropyldiphenylmethane-4,4′-diisocyanate; 1-ethyl-4-ethoxy-phenyl-2,5-diisocyanate; 1,3,5-tri ethyl benzene-2,4,6-triisocyanate; 1-ethyl-3,5-diisopropyl ben-zene-2,4,6-triisocyanate, tolidine diisocyanate, and 1,3,5-triisopropyl benzene-2,4,6-triisocyanate.

22. The asphalt composition according to claim 15, wherein the aromatic isocyanate is selected from toluene diisocyanate, polymeric toluene diisocyanate, and 1,5-naphthalene diisocyanate.

23. The asphalt composition according to claim 15, wherein the starting asphalt has a performance grade selected from 70-16, 70-22, 64-16, and 64-22, determined according AASHTO— M320.

24. The asphalt composition according to claim 15, wherein the asphalt composition does not contain any granular material selected from gravel, reclaimed asphalt pavement, sand and filler material.

25. A process for preparing an asphalt composition according to claim 15, said process comprising the steps of:
(A) heating the starting asphalt to a temperature ranging between 110° C. to 190° C.,
(B) adding 0.1 wt. % to 10.0 wt. % of the thermosetting reactive compound to the starting asphalt of step (A), based on the total weight of the asphalt composition, to obtain a reaction mixture, and
(C) stirring the reaction mixture of step (B) at a temperature ranging between 110° C. to 190° C. for at least 2.5 h under an oxygen atmosphere.

26. The process according to claim 25, wherein the temperature in step (A) and (B), independent of each other, is in the range of 110° C. to 150° C.

27. The process according to claim 25, wherein the stirring in step (C) is carried out for at least 4 h.

28. Use of the composition according to claim 15 or the preparation of an asphalt mix composition.
